(19) United States
(12) Patent Application Publication
(10) Pub. No.: US 2025/0296377 A1
(43) Pub. Date: Sep. 25, 2025

(54) PRINTER DEVICE

(71) Applicant: TOSHIBA TEC KABUSHIKI KAISHA, Tokyo (JP)

(72) Inventor: Hiroyuki Taki, Mishima Shizuoka (JP)

(21) Appl. No.: 19/046,555

(22) Filed: Feb. 6, 2025

(30) Foreign Application Priority Data
Mar. 22, 2024 (JP) 2024-046697

(51) Int. Cl. B41J 33/36; B41J 2/325; B41J 3/407; B41J 11/00; B41J 11/04; B41J 33/44

(52) U.S. Cl. CPC B41J 33/36; B41J 2/325; B41J 3/4075; B41J 11/0095; B41J 11/04; B41J 33/44

(57) ABSTRACT

A printer device in an embodiment includes a conveying unit including a platen roller configured to convey a medium, a supply unit configured to supply an ink ribbon at supply speed corresponding to conveying speed of the medium, a thermal head configured to transfer ink of the ink ribbon to the medium to perform printing, a moving unit configured to move a disposition position of the thermal head, and a control unit configured to control the supply unit and the moving unit and perform a ribbon save operation for, in a start position of a nonprinting region, separating the thermal head from the platen roller and starting deceleration of the ink ribbon and, according to an end position of the nonprinting region, accelerating the ink ribbon to the supply speed and bringing the thermal head close to the platen roller.

### CROSS-REFERENCE TO RELATED APPLICATION

This application is based upon and claims the benefit of priority from Japanese Patent Application No. 2024-046697, filed on Mar. 22, 2024, the entire contents of which are incorporated herein by reference.

### FIELD

Embodiments described herein relate generally to a printer device, a method for a printer, and a label printer.

### BACKGROUND

There is a printer device of a thermal transfer type that heats an ink ribbon and performs printing on a medium such as paper. The printer device delivers the ink ribbon at supply speed corresponding to paper conveying speed (printing speed) and brings, with a thermal head, the ink ribbon into contact with the medium to perform printing.

There has been proposed a technique for controlling, according to a nonprinting region where printing is not performed and a printing region where printing is performed, a head position of a thermal head and supply speed of an ink ribbon to save consumption of the ink ribbon. For example, the thermal head is separated from a medium to stop the supply of the ink ribbon in a start position of the nonprinting region, the supply of the ink ribbon is resumed a little before an end of the nonprinting region, and the thermal head is brought into contact with the medium in an end position of the nonprinting region.

However, in the related art explained above, since the moment of inertia occurs at a supply stop time and a supply resumption time of the ink ribbon, the ink ribbon is excessively delivered by a distance obtained by adding up a distance until the ink ribbon stops and a distance until the ink ribbon is accelerated to the supply speed.

### DESCRIPTION OF THE DRAWINGS

FIG. 1 is a diagram illustrating a schematic configuration of a label printer according to an embodiment;

FIG. 2 is a diagram illustrating an example of hardware components of the label printer;

FIG. 3 is a timing chart illustrating a reference example of a ribbon save operation of the related art;

FIG. 4 is a timing chart illustrating an example of a ribbon save operation performed by the label printer; and

FIG. 5 is a flowchart illustrating an example of ribbon save processing executed by the label printer.

### DETAILED DESCRIPTION

An aspect of embodiments is to provide a printer device capable of achieving a reduction in an amount used of an ink ribbon in a nonprinting region.

A printer device in an embodiment includes: a conveying unit including a platen roller configured to convey a medium; a supply unit configured to supply an ink ribbon at supply speed corresponding to conveying speed of the medium; a thermal head disposed to face the platen roller via the medium and the ink ribbon and configured to transfer ink of the ink ribbon to the medium to perform printing; a moving unit configured to move a disposition position of the thermal head with respect to the platen roller; and a control unit configured to control the supply unit and the moving unit and perform a ribbon save operation for, in a start position of a nonprinting region where printing is not performed on the medium, separating the thermal head from the platen roller and starting deceleration of the ink ribbon and, according to an end position of the nonprinting region, accelerating the ink ribbon to the supply speed and bringing the thermal head close to the platen roller. In the ribbon save operation, the control unit moves the ink ribbon in an opposite direction to a supply direction and thereafter accelerates the ink ribbon to the supply speed according to the end position of the nonprinting region.

An embodiment is explained in detail below with reference to the drawings. Note that the embodiment explained below is not limiting.

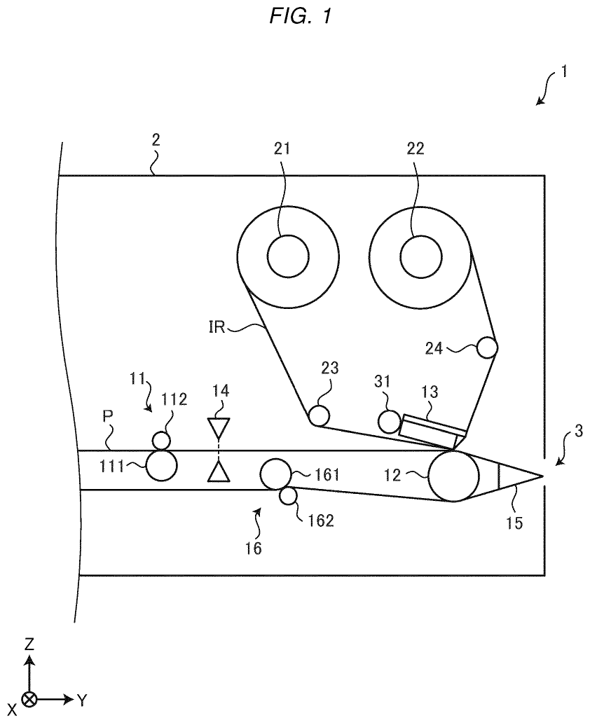

FIG. 1 is a diagram illustrating a schematic configuration of a label printer according to the embodiment. A label printer 1 is an example of the printer device in the present disclosure.

In FIG. 1, an X axis is an axis penetrating the label printer 1 to the left and the right and extending from the left side to the right side of the label printer 1. A Y axis is an axis penetrating the label printer 1 to the front and the rear and extending from the rear to the front of the label printer 1. A Z axis is an axis penetrating the label printer 1 upward and downward and extending from the bottom to the top of the label printer 1. In the following explanation, a positive direction side of the Y axis is referred to as front side of the label printer 1 as well. A negative direction side of the Y axis is referred to as depth side of the label printer 1 as well.

The label printer 1 stores, on the inside of a housing 2, a label roll (not illustrated) obtained by winding label paper P, which is an example of a medium, in a roll shape. The label paper P is obtained by sticking a plurality of labels to a long liner at predetermined intervals. The label printer 1 performs printing on a portion of a label while drawing out the label paper P from the label roll. Note that “printing” in the present embodiment is not limited to printing of characters and signs and is the same concept as “printing” including printing of patterns and the like.

The label printer 1 includes, on the inside of the housing 2, a first conveying roller 11, a platen roller 12, a printing head 13, a label detection sensor 14, a peeling guide 15, and a second conveying roller 16. The label printer 1 includes, on the inside of the housing 2, a ribbon holding shaft 21, a ribbon winding shaft 22, a first guide shaft 23, a second guide shaft 24, and a moving mechanism 31.

The first conveying roller 11 includes a first capstan roller 111 and a first auxiliary roller 112. The label paper P drawn out from the label roll is inserted between the first capstan roller 111 and the first auxiliary roller 112.

The platen roller 12 is disposed in a position facing the printing head 13. The label paper P is inserted between the platen roller 12 and the printing head 13.

The printing head 13 is a thermal head having structure in which a plurality of heat generating bodies are aligned. By causing the heat generating bodies corresponding to a printing pattern to generate heat, the printing head 13 performs printing on a label of the label paper P held between the platen roller 12 and the printing head 13.

Specifically, an ink ribbon IR is inserted between the platen roller 12 and the printing head 13. Ink applied to the ink ribbon IR is transferred to the label of the label paper P by the heated printing head 13.

The label detection sensor 14 is provided in a conveyance route of the label paper P between the first conveying roller 11 and the platen roller 12. The label detection sensor 14 detects a leading end position of the label (or a gap portion between the label and the liner) from the label paper P. For example, the label detection sensor 14 detects, as the leading end position of the label, a portion where a light reception level is a predetermined threshold or more at a conveyance time of the label paper P. The label detection sensor 14 can be implemented by a transmissive sensor configured by a light emitting element and a light receiving element.

A sensor included in the label printer 1 is not limited to the label detection sensor 14. It is assumed that the label printer 1 includes various sensors such as sensors that detect the temperature and the printing concentration of the printing head 13.

The label printer 1 deduces the leading end position of the label on the label paper P based on a detection result of the label detection sensor 14 and performs, for example, position adjustment for positioning the label in a printing start position of the printing head 13 and adjustment of printing timing.

The label paper P for which printing is completed is separated into the liner and the label in the peeling guide 15 that is an example of a peeling unit. The peeling guide 15 is a V-shaped columnar member having two surfaces crossing each other at an acute angle. The peeling guide 15 is installed along an X direction. The peeling guide 15 bends the label paper P conveyed toward a discharge port 3 and peels the label from the liner.

The label peeled from the liner is discharged (dispensed) from the discharge port 3 provided in the housing 2. On the other hand, the liner from which the label is peeled is conveyed into the housing 2 by the second conveying roller 16.

The second conveying roller 16 includes a second capstan roller 161 and a second auxiliary roller 162. The liner peeled by the peeling guide 15 is inserted between the second capstan roller 161 and the second auxiliary roller 162. The second conveying roller 16 conveys the liner to the depth side of the label printer 1. The liner conveyed by the second conveying roller 16 is wound by a not-illustrated winding shaft.

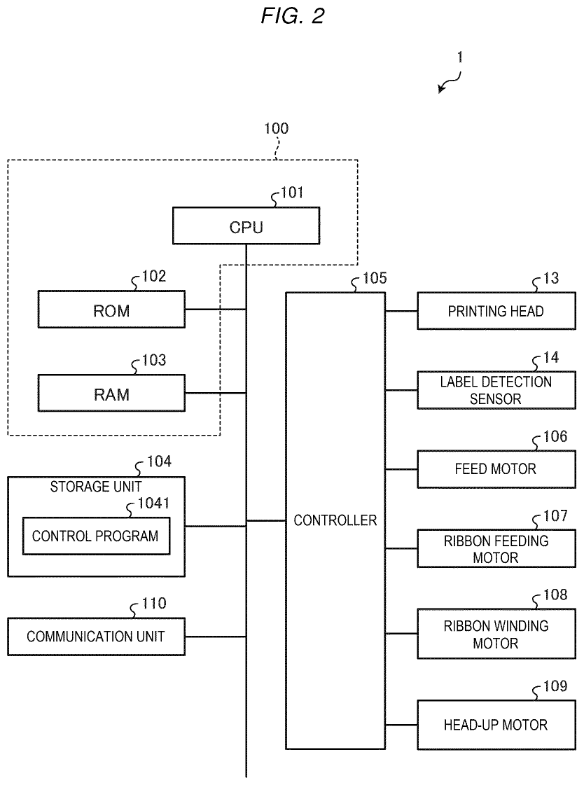

Here, the first conveying roller 11 (the first capstan roller 111) and the platen roller 12 and the second conveying roller 16 (the second capstan roller 161) are driven to rotate by a feed motor 106 (see FIG. 2) explained below. For example, if printing is performed on the label paper P, the feed motor 106 rotates the first capstan roller 111, the platen roller 12, and the second capstan roller 161 clockwise in FIG. 1. Accordingly, the label paper P is conveyed toward the discharge port 3 and the liner of the label paper P from which the label is peeled is conveyed toward the depth side of the label printer 1. In the following explanation, a direction in which the label paper P is conveyed toward the discharge port 3 is referred to as conveying direction as well and a rotating direction of the feed motor 106 that conveys the label paper P toward the discharge port 3 is referred to as “normal rotation direction” as well.

After the completion of the printing of the label, the feed motor 106 is also used if the next label is returned to the printing start position. In this case, the feed motor 106 rotates the first capstan roller 111, the platen roller 12, and the second capstan roller 161 counterclockwise in FIG. 1 to convey the label paper P in the opposite direction to the conveying direction.

The ink ribbon IR is suspended between the ribbon holding shaft 21 and the ribbon winding shaft 22. The ink ribbon IR not used is wound around the ribbon holding shaft 21 in a roll shape. The ribbon winding shaft 22 is a shaft that winds the ink ribbon IR delivered from the ribbon holding shaft 21. The first guide shaft 23 and the second guide shaft 24 are guide members for guiding the ink ribbon IR suspended between the ribbon holding shaft 21 and the ribbon winding shaft 22 to a predetermined position.

The ribbon holding shaft 21 is driven to rotate by a ribbon feeding motor 107 explained below. The ribbon winding shaft 22 is driven to rotate by a ribbon winding motor 108 explained below. In order to supply the ink ribbon IR to the printing head 13 if the label paper P is printed, the ribbon holding shaft 21 and the ribbon winding shaft 22 are driven to rotate by the ribbon feeding motor 107 and the ribbon winding motor 108. Accordingly, the ink ribbon IR is delivered from the ribbon holding shaft 21 to the ribbon winding shaft 22 in a state in which constant tension is applied to the ink ribbon IR.

In the following explanation, a direction in which the ink ribbon IR is delivered from the ribbon holding shaft 21 to the ribbon winding shaft 22 is referred to as “supply direction” as well. If the ribbon holding shaft 21 and the ribbon winding shaft 22 are rotated counterclockwise in FIG. 1, a rotating direction of the ribbon feeding motor 107 is referred to as “feeding direction” as well and a rotating direction of the ribbon winding motor 108 is referred to as “winding direction” as well. If the ribbon holding shaft 21 and the ribbon winding shaft 22 are rotated clockwise in FIG. 1, a rotating direction of the ribbon feeding motor 107 is referred to as “stretching direction” as well and a rotating direction of the ribbon winding motor 108 is referred to as “restoring direction” as well.

The printing head 13 is configured such that a disposition position of the printing head 13 with respect to the platen roller 12 can be moved by the moving mechanism 31 including, as a driving source, a head-up motor 109 explained below. The moving mechanism 31 is capable of switching, with driving of the head-up motor 109, a state in which the printing head 13 is in contact with the platen roller 12 and a noncontact state in which the printing head 13 is separated from the platen roller 12.

The printing head 13 is brought into contact with the platen roller 12 if printing is performed on the label paper P. If the printing head 13 comes into contact with the platen roller 12, the ink ribbon IR is held between the printing head 13 and the platen roller 12. While the printing is performed, the ink ribbon IR is delivered from the ribbon holding shaft 21 at supply speed corresponding to conveying speed of the label paper P by the ribbon feeding motor 107 and the ribbon winding motor 108. The ink ribbon IR used for the printing by the printing head 13 is sequentially wound by the ribbon winding shaft 22.

The printing head 13 is separated from the platen roller 12 in a nonprinting period in which printing is not performed on the label paper P. Then, the ink ribbon IR is separated from the label paper P (the platen roller 12) and the delivery from the ribbon holding shaft 21 is stopped. Accordingly, the label printer 1 prevents the ink ribbon IR from being carelessly consumed in the nonprinting period of the label paper P.

Note that, in the present embodiment, the nonprinting period of the label paper P means a time in which printing is not performed on the label paper P in a state in which conveyance in the conveying direction of the label paper P is maintained. Specifically, the nonprinting period is a time obtained by dividing the length of a “nonprinting region” explained below in the conveying direction of the label paper P by conveying speed of the label paper P.

Subsequently, hardware components of the label printer 1 are explained. FIG. 2 is a diagram illustrating an example of the hardware components of the label printer 1.

As illustrated in FIG. 2, the label printer 1 includes a CPU (Central Processing Unit) 101, a ROM (Read Only Memory) 102, and a RAM (Random Access Memory) 103.

The CPU 101 is an example of a processor and is a control entity of the label printer 1. The ROM 102 stores various programs. Programs and various data are loaded in the RAM 103. The CPU 101, the ROM 102, and the RAM 103 are connected via a bus or the like. The CPU 101, the ROM 102, and the RAM 103 configure a control unit 100. That is, the CPU 101 operates according to a control program 1041 stored in the ROM 102 or a storage unit 104 explained below and loaded in the RAM 103, whereby the control unit 100 executes various kinds of control processing relating to an operation of the label printer 1.

The storage unit 104 is configured by a nonvolatile memory such as an HDD (Hard Disc Drive), a flash memory, or an SSD (Solid State Drive) in which stored information is retained even if the power is turned off. The storage unit 104 stores the control program 1041 for controlling the operation of the label printer 1. The storage unit 104 stores various kinds of setting information relating to the operation of the label printer 1.

The control unit 100 is connected to, via the bus or the like, a controller 105 that controls data input and output. Besides the printing head 13, the label detection sensor 14, and the like explained above, the feed motor 106, the ribbon feeding motor 107, the ribbon winding motor 108, the head-up motor 109, and the like are connected to the controller 105.

The feed motor 106 is a driving source for the first conveying roller 11 (the first capstan roller 111), the platen roller 12, and the second conveying roller 16 (the second capstan roller 161). The ribbon feeding motor 107 is a driving source for the ribbon holding shaft 21. The ribbon winding motor 108 is a driving source for the ribbon winding shaft 22. The head-up motor 109 is a driving source for the moving mechanism 31.

Here, the feed motor 106 functions as, together with the first conveying roller 11, the platen roller 12, the second conveying roller 16, and the like explained above, an example of a conveying unit that conveys the label paper P. The ribbon feeding motor 107 and the ribbon winding motor 108 function as, together with the ribbon holding shaft 21, the ribbon winding shaft 22, and the like, an example of a supply unit that supplies the ink ribbon IR. The head-up motor 109 functions as, together with the moving mechanism 31, an example of a moving unit that moves a disposition position of the printing head 13 with respect to the platen roller 12.

Any one or all of the feed motor 106, the ribbon feeding motor 107, the ribbon winding motor 108, and the head-up motor 109 are implemented by, for example, a DC motor or a stepping motor. In the present embodiment, it is assumed that at least the ribbon feeding motor 107 and the ribbon winding motor 108 are implemented by a stepping motor.

In the present embodiment, the driving source for the first conveying roller 11, the platen roller 12, and the second conveying roller 16 is the common feed motor 106. However, not only this, but, for example, driving sources may be individually provided for each of the rollers. In the present embodiment, the driving sources for the ribbon holding shaft 21 and the ribbon winding shaft 22 are individually provided. However, not only this, but the ribbon holding shaft 21 and the ribbon winding shaft 22 may be driven by a common driving source.

The controller 105 outputs detection results of the various sensors such as the label detection sensor 14 to the control unit 100. The controller 105 receives an instruction from the control unit 100 and controls operations of the units of the label printer 1. For example, the controller 105 receives an instruction from the control unit 100 and controls operations of the feed motor 106, the ribbon feeding motor 107, the ribbon winding motor 108, and the head-up motor 109.

The control unit 100 is connected to the communication unit 110 via the bus or the like. The communication unit 110 communicates with an external device such as an information processing device via a not-illustrated communication line. For example, the communication unit 110 acquires printing data to be printed on a label from the external device or acquires an instruction to print. The communication line may be a wired communication line or may be a wireless communication line.

The hardware components of the label printer 1 are not limited to the components illustrated in FIG. 2. For example, the label printer 1 may include an operation unit for receiving operation from a user and a display unit that displays various kinds of information. It is assumed that not-illustrated various sensors and the like are connected to the controller 105.

In the label printer 1 having the configuration explained above, the control unit 100 cooperates with the control program 1041 to control the operations of the units of the label printer 1 and prints, for example, characters and a barcode on the label paper P.

Specifically, the control unit 100 generates, from data representing a character string or a pattern of a printing target such as a barcode, printing data in which the data is configured by data in dot units. The control unit 100 divides the generated printing data in one line unit printed by the heat generating elements of the printing head 13 to generate line printing data. In the line printing data, a portion where printing is performed is represented as a dot pattern. For example, if the resolution of printing is 360 dpi, line printing data divided into 360 lines per one inch is generated.

The control unit 100 controls ON/OFF, an energization time, and the like of the heat generating elements of the printing head 13 based on the dot pattern of the line printing data to perform printing for one line. The control unit 100 sequentially performs printing of lines according to conveying speed of the label paper P to form the barcode or the like of the printing target on the label of the label paper P.

If a nonprinting region where printing is not performed is present in a plurality of line printing data generated for each of lines, the control unit 100 executes control for suppressing consumption of the ink ribbon IR (hereinafter referred to as ribbon save operation as well). Here, the nonprinting region means a region where line printing data without a dot pattern for performing printing is continuous in a series of line printing data configuring printing data.

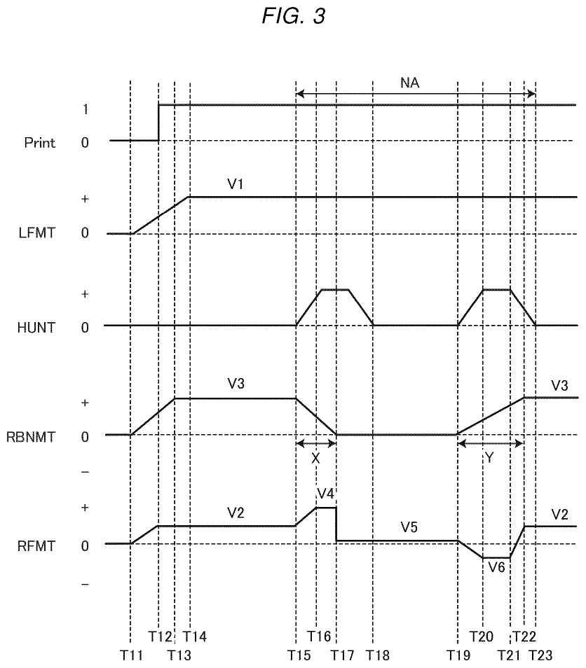

The ribbon save operation performed by the control unit 100 is explained below. First, for comparison with the ribbon save operation performed by the control unit 100 in the present embodiment, a reference example of a ribbon save operation performed in the related art is explained with reference to FIG. 3. A printer device of an operation entity assumed in FIG. 3 includes the same hardware components as the hardware components of the label printer 1 in the present embodiment. In the following explanation, a subject of an operation is described as a reference example and the printer device assumed in FIG. 3 is explained using the configuration of the label printer 1 explained above.

FIG. 3 is a timing chart illustrating a reference example of the ribbon save operation of the related art. The horizontal axis indicates a time axis. On the vertical axis, “Print” indicates ON/OFF of printing, “LEMT” indicates a speed change of the feed motor 106, “HUMT” indicates a speed change of the head-up motor 190, “RBNMT” indicates a speed change of the ribbon winding motor 108, and “RFMT” indicates a speed change of the ribbon feeding motor 107. It is assumed that the printing data includes a nonprinting region NA.

“0” of the “Print” means a state in which printing is not performed. “1” of the “Print” means a state in which printing is performed. “0” of the “LFMT”, the “HUMT”, the “RBNMT”, and the “RFMT” means a state in which a motor is stopped. A + direction of the “LFMT” means rotation in the normal rotation direction. A + direction of the “RBNMT” means rotation in the winding direction. A − direction of the “RBNMT” means rotation in the restoring direction. A + direction of the “RFMT” means rotation in the stretching direction. A − direction of the “RFMT” means rotation in the feeding direction. In FIG. 3, it is assumed that, in an initial state before time T11, the printing head 13 is in a state of contact with the platen roller 12.

First, in the reference example, at time T11, normal rotation of the feed motor 106 is started and the feed motor 106 is accelerated to predetermined speed V1. Accordingly, conveyance of the label paper P is started. In the reference example, according to the conveyance start of the label paper P, rotation of the ribbon winding motor 108 in the winding direction and rotation of the ribbon feeding motor 107 in the stretching direction are started to start supply of the ink ribbon IR. Here, the rotation of the ribbon feeding motor 107 in the stretching direction is rotation for applying predetermined tension to the ink ribbon IR. Acceleration of the ribbon feeding motor 107 in the stretching direction is smaller than acceleration in the winding direction of the ribbon winding motor 108.

Subsequently, in the reference example, printing of printing data is started at time T12 and speed of the ribbon feeding motor 107 in the stretching direction is set to constant speed of V2. In the reference example, if speed of the ribbon winding motor 108 in the winding direction reaches speed V3 at subsequent time T13, the speed V3 is maintained. In the reference example, if speed of the feed motor 106 in the normal rotation direction reaches speed V1 at the subsequent time T14, the speed is maintained. Accordingly, the label paper P and the ink ribbon IR are moved at constant conveying speed and supply speed. The ink ribbon IR is supplied at supply speed (for example, equivalent speed) corresponding to the conveying speed of the label paper P.

In the reference example, if the ink ribbon IR reaches a start position of the nonprinting region NA at subsequent time T15, driving of the head-up motor 109 is started, whereby the printing head 13 is separated from the platen roller 12. In the reference example, the supply of the ink ribbon IR is stopped, whereby deceleration of the ribbon winding motor 108 is started at time T15. At this time, in order to prevent a bend of the ink ribbon IR involved in the deceleration of the ribbon winding motor 108, the speed of the ribbon feeding motor 107 in the stretching direction is increased. If the speed reaches predetermined speed V4 at time T16, the speed is maintained.

If the ribbon winding motor 108 stops at subsequent time T17 and the ribbon feeding motor 107 pulls the ink ribbon IR according to the rotation of the ribbon feeding motor 107 in the stretching direction, in the reference example, a stretching state of the ink ribbon IR is maintained by setting the speed of the ribbon feeding motor 107 in the stretching direction to very small speed V5. Accordingly, the supply of the ink ribbon IR is in a stopped state. Note that the driving of the head-up motor 109 is stopped at time T18 when the distance between the printing head 13 and the platen roller 12 reaches a predetermined amount.

Subsequently, in the reference example, the printing head 13 is moved toward the platen roller 12 by starting driving of the head-up motor 109 at timing of time T19 preceding an end position of the nonprinting region NA. The ribbon winding motor 108 is accelerated to the speed V3 by starting rotation of the ribbon winding motor 108 in the winding direction. Further, in the reference example, in order to urge the supply of the ink ribbon IR, the ribbon feeding motor 107 is rotated in the feeding direction and, if the speed of the ribbon motor 107 reaches speed V6 at time T20, the speed V6 is maintained. In the reference example, rotation of the ribbon feeding motor 107 in the stretching direction is started at time T21 such that the speed in the stretching direction reaches V2 at timing when the speed of the ribbon winding motor 108 in the winding direction reaches the speed V3.

In the reference example, if the speed of the ribbon winding motor 108 in the winding direction reaches the speed V3 at time T22, the speed V3 is maintained. In the reference example, if the speed of the ribbon feeding motor 107 in the stretching direction reaches the speed V2 at timing of time T22, the speed V2 is maintained. The driving of the head-up motor 109 is stopped at time T23 when the nonprinting region ends. The printing head 13 is brought into contact with the platen roller 12.

As explained above, in the ribbon save operation in the reference example, the supply (the delivery) of the ink ribbon IR is stopped in the nonprinting region NA. Therefore, it is possible to reduce a consumption amount of the ink ribbon IR in the nonprinting region NA.

Incidentally, in the ribbon save operation in the reference example, the moment of inertia acts if the ribbon winding motor 108 is decelerated from the speed V3 to a stop state of speed zero (a period X in FIG. 3) and if the ribbon winding motor 108 is accelerated from the stop state of speed zero to the speed V3 (a period Y in FIG. 3). Therefore, the ink ribbon IR is delivered in the supply direction during the deceleration and during the acceleration. In particular, if the printing speed (the conveying speed of the label paper P) is high, since a delivery distance in the supply direction by the moment of inertia increases, the consumption amount of the ink ribbon IR in the nonprinting region NA increases.

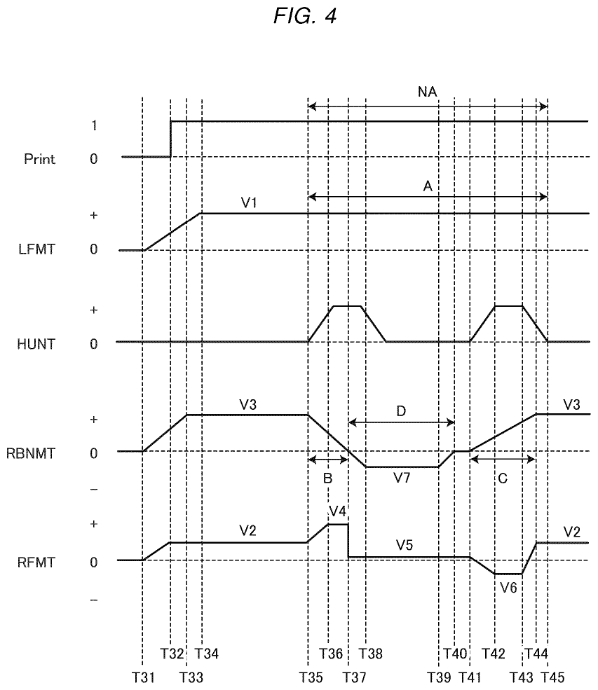

Therefore, in the label printer 1 in the present embodiment, in order to reduce the consumption amount of the ink ribbon IR in the nonprinting region NA explained above, the control unit 100 executes a ribbon save operation different from the ribbon save operation in the reference example explained above. Specifically, the control unit 100 executes a ribbon save operation illustrated in FIG. 4.

Here, FIG. 4 is a timing chart illustrating an example of a ribbon save operation performed by the label printer 1 in the present embodiment. In FIG. 4, the vertical axis and the horizontal axis are the same as those in FIG. 3. Control content of the control unit 100 executed until the ink ribbon IR reaches the nonprinting region (time T31 to time T35) is the same as the control content at time T11 to time T15 in FIG. 3 explained above. Therefore, explanation of the control content is omitted.

In the timing chart of FIG. 4, if the ink ribbon IR reaches the start position of the nonprinting region NA at time T35, the control unit 100 drives the head-up motor 109 and separates the printing head 13 from the platen motor 12. The control unit 100 changes the rotating direction of the ribbon winding motor 108 to the restoring direction at time T35 to decelerate the ribbon winding motor 108 to speed V7 in the restoring direction. Here, deceleration speed of the ribbon winding motor 108 is the same as the deceleration speed at time T15 to time T17 in FIG. 3. In order to prevent a bend of the ink ribbon IR, the control unit 100 increases the speed of the ribbon feeding motor 107 in the stretching direction at time T35 and, if the speed reaches the speed V4 at time T36, maintains the speed V4.

If the ribbon feeding motor 107 pulls the ink ribbon IR at timing of subsequent time T37, the control unit 100 sets the speed of the ribbon feeding motor 107 in the stretching direction to very small speed V5. On the other hand, the deceleration of the ribbon winding motor 108 is continued even at time T37 and subsequent time. If the speed in the restoring direction reaches the speed V7 at subsequent time T38, the control unit 100 maintains the speed V7. Accordingly, the ink ribbon IR is moved in the restoring direction at time T37 and subsequent time.

Subsequently, the control unit 100 starts, at time T39, deceleration for stopping the ribbon winding motor 108 and stops the ribbon winding motor 108 at time T40. The control unit 100 maintains the speed V5 of the ribbon feeding motor 107 in the stretching direction to stop the ink ribbon IR in a state in which predetermined tension is applied to the ink ribbon IR.

The control unit 100 calculates, as explained below, a distance in which the ink ribbon IR is moved in the restoring direction from time T37 to time T40 (hereinafter referred to as restoring distance as well). The control unit 100 sets, as the restoring distance, a value obtained by adding up a supply amount (length) of the ink ribbon IR supplied from when deceleration of the ribbon winding motor 108 is started in a start position of the nonprinting region NA until the speed reaches a speed zero state and a supply amount (length) of the ink ribbon IR supplied from the speed zero state at time T41 until the speed reaches the speed V3. More specifically, the control unit 100 sets, as the restoring distance, a value obtained by adding up a supply amount of the ink ribbon IR delivered from time T35 to time T37 and a supply amount of the ink ribbon IR delivered from time T41 to time T44 explained below. Accordingly, positions on the ink ribbon IR can be set substantially the same in the start position and an end position of the nonprinting region NA.

Subsequently, the control unit 100 starts driving of the head-up motor 109 at timing of time T41 preceding the end position of the nonprinting region NA to move the printing head 13 toward the platen roller 12. Then, at time T41 to time T45, the control unit 100 performs the same control as the control at time T19 to time T23 in the reference example explained above.

Here, if the ribbon save operation in the reference example and the ribbon save operation of the control unit 100 are compared, the ribbon save operations are the same in stopping the supply of the ink ribbon IR in the nonprinting region NA. However, in the ribbon save operation of the control unit 100, after returning the ink ribbon IR by a distance corresponding to delivery at the deceleration time and the acceleration time, the supply speed of the ink ribbon IR is restored.

Accordingly, in the label printer 1 in the present embodiment, a position on the ink ribbon IR in contact with the printing head 13 in the end position of the nonprinting region NA can be set as a position on the ink ribbon IR in contact with the printing head 13 at the start position of the nonprinting region NA. Therefore, in the label printer 1 in the present embodiment, compared with the existing printer, it is possible to more efficiently reduce the consumption amount of the ink ribbon IR in the nonprinting region NA.

The control unit 100 preferably determines, based on, for example, specifications of the conveying unit for the label paper P and the supply unit for the ink ribbon IR, whether the ribbon save operation explained above can be executed in the nonprinting region NA and, if the ribbon save operation can be executed, performs the ribbon save operation. The control unit 100 can determine, based on, for example, the nonprinting period A of the nonprinting region obtained by dividing the length of the nonprinting region NA in the conveying direction by the conveying speed of the label paper P, whether the ribbon save operation can be executed.

Specifically, if a total time E obtained by adding up a time B required for deceleration from time T35 to time T37, a time C required for acceleration from time T41 to time T44, and a time D required for movement in the restoring distance from time T37 to time T40 is shorter than the nonprinting period A, the control unit 100 may determine that the ribbon save operation can be executed. In this case, the control unit 100 can set positions on the ink ribbon IR substantially the same in the start position and the end position of the nonprinting region NA by performing the ribbon save operation. Therefore, it is possible to surely perform a consumption amount reduction of the ink ribbon IR.

If the total time E is equal to or longer than the nonprinting period A, the control unit 100 may perform the ribbon save operation of the related art explained with reference to FIG. 3 or may continue the supply of the ink ribbon even in the nonprinting region NA without performing the ribbon save operation.

If the total time E is equal to or longer than the nonprinting period A, the control unit 100 may change setting relating to the ribbon save operation to perform the ribbon save operation within a range of the nonprinting period A. For example, if the total time E is equal to or longer than the nonprinting period A and a total time of the time B and the time C is shorter than the nonprinting period A, the control unit 100 may reduce the time D to be within the range of the nonprinting period A and perform the ribbon save operation. Accordingly, the control unit 100 can return the ink ribbon IR during the reduced time D. Therefore, compared with the existing printer, it is possible to achieve a consumption amount reduction of the ink ribbon IR in the nonprinting region NA.

For example, if the total time E is equal to or longer than the nonprinting period A and the total time E after changing the magnitude of the deceleration speed and/or the acceleration speed of the ribbon winding motor 108 is shorter than the printing period A, the control unit 100 may perform the ribbon save operation with the setting after the change. Accordingly, the control unit 100 can set the positions on the ink ribbon IR substantially the same in the start position and the end position of the nonprinting region NA. Therefore, it is possible to perform the consumption amount reduction of the ink ribbon IR. In this example, if the total time E after the change is equal to or longer than the nonprinting period A, the control unit 100 may not perform the ribbon save operation or may reduce the time D as explained above.

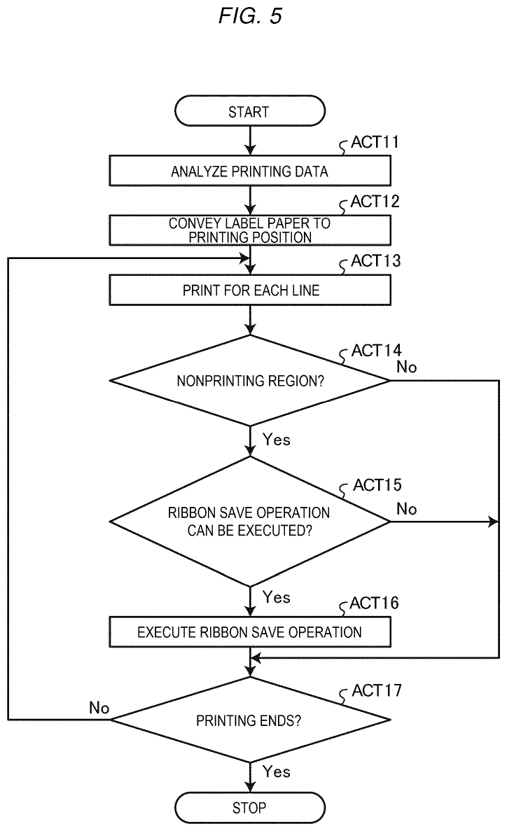

Subsequently, an operation example of the label printer 1 in the present embodiment is explained with reference to FIG. 5. FIG. 5 is a flowchart illustrating an example of ribbon save processing executed by the label printer 1 in the embodiment. It is assumed that, as a premise of the processing, printing target data (printing data) is already acquired.

First, prior to printing of printing data, the control unit 100 analyzes the printing data to, for example, detect presence or absence of a nonprinting region and a start position and an end position of the nonprinting region (Act 11). The analysis of the printing data is not limited to be performed before the printing. The control unit 100 may analyze the printing data in parallel to printing processing while pre-reading line printing data for several ten to several hundred lines.

Subsequently, the control unit 100 starts conveying the label paper P and supplying the ink ribbon IR and conveys the label paper P to a printing position of the printing head 13 (Act 12). Subsequently, by controlling the printing head 13 and causing the heat generating elements to generate heat based on a dot pattern of line printing data, the control unit 100 performs printing for each line of the line printing data (Act 13).

Subsequently, the control unit 100 determines whether the ink ribbon IR reached the nonprinting region (Act 14). If the ink ribbon IR did not reach the nonprinting region (No in Act 14), the control unit 100 shifts to Act 17. On the other hand, if determining that the ink ribbon IR reached the nonprinting region (Yes in Act 14), the control unit 100 determines, based on a nonprinting period or the like, whether a ribbon save operation can be executed (Act 15). If determining in Act 15 that the ribbon save operation cannot be executed, the control unit 100 shifts to Act 17. In this case, the control unit 100 causes the ink ribbon IR to pass the nonprinting region while keeping the printing head 13 in contact with the platen roller 12.

On the other hand, if determining in Act 15 that the ribbon save operation can be executed, the control unit 100 executes the ribbon save operation explained with reference to FIG. 4 to reduce a consumption amount of the ink ribbon IR (Act 16). Then, if the nonprinting region ends, the control unit 100 shifts to Act 17.

In subsequent Act 17, the control unit 100 determines whether the printing ends (Act 17). Here, if the printing is continued (No in Act 17) because, for example, the printing data is being printed or printing of a predetermined number of prints is incomplete, the control unit 100 returns the processing to Act 13. If determining that the printing ends because, for example, the printing reached the end of the printing data or the printing of the predetermined number of prints is completed (Yes in Act 17), the control unit 100 ends the processing.

As explained above, the label printer 1 in the present embodiment includes the conveying unit including the platen roller 12 that conveys the label paper P, the supply unit that supplies the ink ribbon IR at supply speed corresponding to conveying speed of the label paper P, the printing head 13 that is disposed to face the platen roller 12 via the label paper P and the ink ribbon IR and transfers ink of the ink ribbon IR to the label paper P to perform printing, the moving mechanism 31 that moves a disposition position of the printing head 13 with respect to the platen roller 12, and the control unit 100 that controls the supply unit and the moving mechanism 31 and performs a ribbon save operation for, in a start position of a nonprinting region where printing is not performed on the label paper P, separating the printing head 13 from the platen roller 12 and starting deceleration of the ink ribbon IR and, according to an end position of the nonprinting region, accelerating the ink ribbon IR to the supply speed and bringing the printing head 13 close to the platen roller 12. In the ribbon save operation, the control unit 100 moves the ink ribbon IR in the opposite direction to a supply direction and thereafter accelerates the ink ribbon IR to the supply speed according to the end position of the nonprinting region.

Accordingly, in the label printer 1 in the present embodiment, in the ribbon save operation in the nonprinting region, after the ink ribbon IR is moved in the opposite direction to the supply direction, the ink ribbon IR can be restored to the supply speed. Therefore, the label printer 1 in the present embodiment can reduce, according to the movement in the opposite direction, a supply amount of the ink ribbon IR delivered at the deceleration time and the acceleration time of the ink ribbon IR. Therefore, it is possible to achieve a reduction in an amount used of the ink ribbon in the nonprinting region.

After moving the ink ribbon IR in the opposite direction by a predetermined amount such that positions on the ink ribbon IR are the same in a start position and an end position of the nonprinting region, the label printer 1 in the present embodiment accelerates the ink ribbon IR to the supply speed according to the end position of the nonprinting region.

Accordingly, in the label printer 1 in the present embodiment, in the ribbon save operation in the nonprinting region, the positions on the ink ribbon IR can be set the same in the start position and the end position of the nonprinting region. Therefore, it is possible to reduce an amount used of the ink ribbon in the nonprinting region.

The label printer 1 in the present embodiment moves, in the opposite direction, the ink ribbon IR by a movement amount equivalent to length obtained by adding up the length of the ink ribbon IR delivered from when the deceleration of the ink ribbon IR is started until the speed in the supply direction decreases to zero and the length of the ink ribbon IR delivered from when the acceleration of the ink ribbon IR is started until the speed reaches the supply speed.

Accordingly, in the label printer 1 in the present embodiment, in the ribbon save operation in the nonprinting region, the positions on the ink ribbon IR can be set the same in the start position and the end position of the nonprinting region. Therefore, it is possible to reduce an amount used of the ink ribbon in the nonprinting region.

Prior to the ribbon save operation, the label printer 1 in the present embodiment calculates a total time of a time from when the deceleration of the ink ribbon IR is started until the speed in the supply direction decreases to zero, a time to execute a movement of the ink ribbon in the opposite direction, and a time from a state in which the speed in the supply direction is zero until the ink ribbon is accelerated to the supply speed and, if the total time is shorter than the nonprinting period required for conveyance in the nonprinting region, executes the ribbon save operation.

Accordingly, in the label printer 1 in the present embodiment, if the ribbon save operation can be surely executed within the nonprinting period, the ribbon save operation can be executed. Therefore, it is possible to achieve a reduction in an amount used of the ink ribbon in the nonprinting region and prevent occurrence of a printing error and the like due to the ribbon save operation.

If the total time is equal to or longer than the nonprinting period, the label printer 1 in the present embodiment adjusts a movement amount of the ink ribbon IR moved in the opposite direction and executes the ribbon save operation within the nonprinting period.

Accordingly, in the label printer 1 in the present embodiment, the ribbon save operation can be executed within a range of the nonprinting period. Therefore, it is possible to achieve a reduction in an amount used of the ink ribbon in the nonprinting region and prevent occurrence of a printing error and the like due to the ribbon save operation.

If the total time is equal to or longer than the nonprinting period, the label printer 1 in the present embodiment adjusts the magnitude of the deceleration speed and/or the acceleration speed of the ink ribbon IR and executes the ribbon save operation within the nonprinting period.

Accordingly, in the label printer 1 in the present embodiment, the ribbon save operation can be executed within a range of the nonprinting period. Therefore, it is possible to achieve a reduction in an amount used of the ink ribbon in the nonprinting region and prevent occurrence of a printing error and the like due to the ribbon save operation.

Note that the embodiment explained above can be modified and implemented as appropriate by changing a part of the components or the functions of the devices explained above. Therefore, in the following explanation, several modifications relating to the embodiment explained above are explained as other embodiments. In the following explanation, differences from the embodiment explained above are mainly explained. Detailed explanation is omitted about similarities to the contents explained above. The modifications explained below may be individually implemented or may be implemented in combination as appropriate.

### Modification 1

In the embodiment explained above, the label printer 1 that performs printing on the label paper P is explained. However, the printer device to which the embodiment is applied is not limited to this. For example, the embodiment can also be applied to printer devices such as a receipt printer that performs printing on an medium that does not need to be peeled and a barcode printer.

### Modification 2

In the embodiment explained above, in the ribbon save operation, after the ink ribbon IR is moved in the opposite direction, a stop period (time T40 to time T41 in FIG. 4) in which the paper winding motor 108 is stopped is provided. However, not only this, but the stop period may not be provided.

For example, the stop period can be used as an adjustment time for the time D for moving the ink ribbon IR in the opposite direction in the ribbon save operation and the time C for performing acceleration from the stop state to the speed V3. However, control for accelerating the ink ribbon IR at a time from the speed V7 in the restoring direction to the speed V3 in the winding direction may be performed without providing the stop period.

### Modification 3

In the embodiment explained above, the conveying speed of the label paper P is not particularly referred to. However, the conveying speed of the label paper P may be constant speed or may be able to be changed according to, for example, a type of a medium. Note that the control unit 100 adjusts, according to the conveying speed, a distance and timing for moving the ink ribbon IR in the opposite direction in the ribbon save operation.

The embodiment is explained above. However, the embodiment is presented as an example and is not intended to limit the scope of the invention. The new embodiment can be implemented in other various forms. Various omissions, substitutions, changes, and combinations can be made without departing from the gist of the invention. The embodiment and modifications of the embodiment are included in the scope and the gist of the invention and included in the inventions described in claims and the scope of equivalents of the inventions.

What is claimed is:

1. A printer device, comprising:
a conveying component including a platen roller configured to convey a medium;
a supply component configured to supply an ink ribbon at a supply speed corresponding to a conveying speed of the medium;
a thermal head disposed to face the platen roller via the medium and the ink ribbon and configured to transfer ink of the ink ribbon to the medium to perform printing;
a moving component configured to move a disposition position of the thermal head with respect to the platen roller; and
a controller configured to control the supply component and the moving component and perform a ribbon save operation for, in a start position of a nonprinting region where printing is not performed on the medium, separating the thermal head from the platen roller and starting deceleration of the ink ribbon and, according to an end position of the nonprinting region, accelerating the ink ribbon to the supply speed and bringing the thermal head close to the platen roller, wherein
in the ribbon save operation, the controller moves the ink ribbon in an opposite direction to a supply direction and thereafter accelerates the ink ribbon to the supply speed according to the end position of the nonprinting region.

2. The printer device according to claim 1, wherein the controller moves the ink ribbon in the opposite direction by a predetermined amount such that positions on the ink ribbon are same in a start position and an end position of the nonprinting region and thereafter accelerates the ink ribbon to the supply speed according to the end position of the nonprinting region.

3. The printer device according to claim 2, wherein the controller moves, in the opposite direction, the ink ribbon by a movement amount equivalent to length obtained by adding up a first length of the ink ribbon supplied from when the deceleration of the ink ribbon is started until the speed in the supply direction decreases to zero and a second length of the ink ribbon supplied from when the acceleration of the ink ribbon is started until the speed reaches the supply speed.

4. The printer device according to claim 1, wherein, prior to the ribbon save operation, the controller calculates a total time of a first time from when the deceleration of the ink ribbon is started until speed in the supply direction decreases to zero, a second time to execute a movement of the ink ribbon in the opposite direction, and a third time from a state in which the speed in the supply direction is zero until the ink ribbon is accelerated to the supply speed and, if the total time is shorter than a conveyance time required for conveyance in the nonprinting region, executes the ribbon save operation.

5. The printer device according to claim 4, wherein, if the total time is equal to or longer than the conveyance time, the controller adjusts a movement amount of the ink ribbon moved in the opposite direction and executes the ribbon save operation.

6. The printer device according to claim 4, wherein, if the total time is equal to or longer than the conveyance time, the controller adjusts magnitude of at least one of the deceleration speed and the acceleration speed of the ink ribbon and executes the ribbon save operation.

7. The printer device according to claim 1, further comprising a label detection sensor provided in a conveyance route of the medium between a first conveying roller and the platen roller, the label detection sensor configured to detect a leading end position of a label on the medium.

8. A method for a printer, comprising:
conveying a medium using a conveying component including a platen roller;
supplying an ink ribbon at a supply speed corresponding to a conveying speed of the medium using a supply component;
transferring ink of the ink ribbon to the medium a thermal head disposed to face the platen roller to perform printing;
moving a disposition position of the thermal head with respect to the platen roller using a moving component;
controlling the supply component and the moving component and performing a ribbon save operation for, in a start position of a nonprinting region where printing is not performed on the medium, separating the thermal head from the platen roller and starting deceleration of the ink ribbon and, according to an end position of the nonprinting region, accelerating the ink ribbon to the supply speed and bringing the thermal head close to the platen roller; and
in the ribbon save operation, moving the ink ribbon in an opposite direction to a supply direction and thereafter accelerating the ink ribbon to the supply speed according to the end position of the nonprinting region.

9. The method according to claim 8, further comprising:
moving the ink ribbon in the opposite direction by a predetermined amount such that positions on the ink ribbon are same in a start position and an end position of the nonprinting region and thereafter accelerating the ink ribbon to the supply speed according to the end position of the nonprinting region.

10. The method according to claim 9, further comprising:
moving, in the opposite direction, the ink ribbon by a movement amount equivalent to length obtained by adding up a first length of the ink ribbon supplied from when the deceleration of the ink ribbon is started until the speed in the supply direction decreases to zero and a second length of the ink ribbon supplied from when the acceleration of the ink ribbon is started until the speed reaches the supply speed.

11. The method according to claim 8, further comprising:
prior to the ribbon save operation, calculating a total time of a first time from when the deceleration of the ink ribbon is started until speed in the supply direction decreases to zero, a second time to execute a movement of the ink ribbon in the opposite direction, and a third time from a state in which the speed in the supply direction is zero until the ink ribbon is accelerated to the supply speed and, if the total time is shorter than a conveyance time required for conveyance in the nonprinting region, executing the ribbon save operation.

12. The method according to claim 11, further comprising:
if the total time is equal to or longer than the conveyance time, adjusting a movement amount of the ink ribbon moved in the opposite direction and executing the ribbon save operation.

13. The method according to claim 11, further comprising:
if the total time is equal to or longer than the conveyance time, adjusting magnitude of at least one of the deceleration speed and the acceleration speed of the ink ribbon and executing the ribbon save operation.

14. A label printer, comprising:
a conveying component including a platen configured to convey a roll medium comprising labels;
a supply component configured to supply an ink ribbon at a supply speed corresponding to a conveying speed of the roll medium;
a thermal head disposed to face the platen roller via the roll medium and the ink ribbon and configured to transfer ink of the ink ribbon to the labels of the roll medium to perform printing;
a moving component configured to move a disposition position of the thermal head with respect to the platen roller; and
a controller configured to control the supply component and the moving component and perform a ribbon save operation for, in a start position of a nonprinting region where printing is not performed on the labels of the roll medium, separating the thermal head from the platen roller and starting deceleration of the ink ribbon and, according to an end position of the nonprinting region, accelerating the ink ribbon to the supply speed and bringing the thermal head close to the platen roller, wherein
in the ribbon save operation, the controller moves the ink ribbon in an opposite direction to a supply direction and thereafter accelerates the ink ribbon to the supply speed according to the end position of the nonprinting region.

15. The label printer according to claim 14, wherein the controller moves the ink ribbon in the opposite direction by a predetermined amount such that positions on the ink ribbon are same in a start position and an end position of the nonprinting region and thereafter accelerates the ink ribbon to the supply speed according to the end position of the nonprinting region.

16. The label printer according to claim 15, wherein the controller moves, in the opposite direction, the ink ribbon by a movement amount equivalent to length obtained by adding up a first length of the ink ribbon supplied from when the deceleration of the ink ribbon is started until the speed in the supply direction decreases to zero and a second length of the ink ribbon supplied from when the acceleration of the ink ribbon is started until the speed reaches the supply speed.

17. The label printer according to claim 14, wherein, prior to the ribbon save operation, the controller calculates a total time of a first time from when the deceleration of the ink ribbon is started until speed in the supply direction decreases to zero, a second time to execute a movement of the ink ribbon in the opposite direction, and a third time from a state in which the speed in the supply direction is zero until the ink ribbon is accelerated to the supply speed and, if the total time is shorter than a conveyance time required for conveyance in the nonprinting region, executes the ribbon save operation.

18. The label printer according to claim 17, wherein, if the total time is equal to or longer than the conveyance time, the controller adjusts a movement amount of the ink ribbon moved in the opposite direction and executes the ribbon save operation.

19. The label printer according to claim 17, wherein, if the total time is equal to or longer than the conveyance time, the controller adjusts magnitude of at least one of the deceleration speed and the acceleration speed of the ink ribbon and executes the ribbon save operation.

20. The label printer according to claim 14, further comprising a label detection sensor provided in a conveyance route of the roll medium between a first conveying roller and the platen roller, the label detection sensor configured to detect a leading end position of a label on the roll medium.
